(19) United States
(12) Patent Application Publication
(10) Pub. No.: US 2011/0060788 A1
(43) Pub. Date: Mar. 10, 2011

(54) SYSTEM AND METHOD FOR AUTOMATICALLY PROVIDING METADATA ELEMENTS ON A WEB PAGE OR WEB SITE

(75) Inventors: Shlomi Haybi, Ornit (IL); Ran Keren, Tel Aviv (IL)

(73) Assignee: ExactFactor, Ltd., Tel Aviv (IL)

(21) Appl. No.: 12/554,346

(22) Filed: Sep. 4, 2009

(51) Int. Cl. G06F 15/16

(52) U.S. Cl. 709/203

(57) ABSTRACT

A system and method for automatically providing Metadata elements in a Web page or Web site is provided. Generally, the system contains a user device having an application therein that allows the user to request access to a Web page or Web site; a Web data server having at least one Web page and/or Web site stored therein; a Metadata server having Metadata elements stored therein; and a content server containing a memory and a processor, wherein the processor is configured by the memory to perform the steps of: retrieving code of the requested Web page or Web site, wherein the code includes at least one calling function, wherein the calling function causes the content server to retrieve Metadata identified by the calling function, from the Metadata server; reading the code of the requested Web page or Web site; retrieving Metadata identified by the calling function, from the Metadata server; and populating the Web page or Web site with the retrieved Metadata.

### FIELD OF THE INVENTION

The present invention is generally related to search engine searching, and more particularly is related to automatic providing of Metadata elements on a Web page or Web site.

### BACKGROUND OF THE INVENTION

Search engine optimization is an important component to online marketing plans. Internet search engines index Web pages by using one or more techniques. One such technique is by searching for Metadata elements using search engine robots, also referred to as spiders. Metadata elements signify the presence of needed information regarding a specific Web page so as to help search engine robots to categorize Web pages during indexing. The Metadata elements are inserted into the Web page by the programmer of the Web page, and are typically not visible to the public unless the public views the source of the Web page. It is noted, however, that title Metadata can be seen without viewing the source of the Web page.

Search engine optimization techniques have called for the use of different methods for providing a Web site with a higher ranking on search engines. Typically, a programmer, or Webmaster, is relied upon to add appropriate Metadata elements to a Web site so that the Web site will be properly categorized by search engine robots. Unfortunately, this requires that the Web site be continuously updated with the appropriate Metadata elements, after which the newly modified Web site is uploaded to a Web data server. This process proves to be time consuming if multiple Web sites are individually maintained by a Webmaster.

Thus, a heretofore unaddressed need exists in the industry to address the aforementioned deficiencies and inadequacies.

### SUMMARY OF THE INVENTION

Embodiments of the present invention provide a system and method for automatically providing Metadata elements on a Web page or Web site. Briefly described, in architecture, one embodiment of the system, among others, can be implemented as follows. The system contains a user device having an application therein that allows the user to request access to a Web page or Web site; a Web data server having at least one Web page and/or Web site stored therein; a Metadata server having Metadata elements stored therein; and a content server containing a memory and a processor, wherein the processor is configured by the memory to perform the steps of: retrieving code of the requested Web page or Web site, wherein the code includes at least one calling function, wherein the calling function causes the content server to retrieve Metadata identified by the calling function, from the Metadata server; reading the code of the requested Web page or Web site; retrieving Metadata identified by the calling function, from the Metadata server; and populating the Web page or Web site with the retrieved Metadata.

The present invention can also be viewed as providing a content server containing: a memory; and a processor configured by the memory to perform the steps of: retrieving code of a requested Web page or Web site, wherein the code includes at least one calling function, wherein the calling function causes the content server to retrieve Metadata identified by the calling function; reading the code of the requested Web page or Web site; retrieving Metadata identified by the calling function from a location remote from the content server; and populating the Web page or Web site with the retrieved Metadata.

The present invention can further be viewed as providing a method for automatically providing Metadata elements on a Web page or Web site. In this regard, one embodiment of such a method, among others, can be broadly summarized by the following steps: retrieving code of a requested Web page or Web site, wherein the code includes at least one calling function; reading the code of the requested Web page or Web site; retrieving Metadata elements identified by the calling function; and populating the Web page or Web site with the retrieved Metadata elements.

Other systems, methods, and advantages of the present invention will be or become apparent to one with skill in the art upon examination of the following drawings and detailed description. It is intended that all such additional systems, methods, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating a basic network in which the present system and method may be provided.

FIG. 2 is a block diagram further illustrating a typical Web data server in accordance with the present system and method.

FIG. 3 is a block diagram further illustrating a typical content server located within the network of FIG. 1.

FIG. 4 is a flow chart illustrating the method used when a user of the client device requests a Web site or Web page, where Metadata for the Web site or Web page is stored separate from the Web site or Web page.

### DETAILED DESCRIPTION

The present system and method provides for automatic insertion of Metadata elements on a Web page and/or Web site via use of a calling function stored on the Web page, where the calling function may be script or code. The Metadata elements are stored at a location remote from the Web page and/or Web site, on the server side, and are called by the calling function located on the Web page and/or Web site. It should be noted that while the following description of the present system and method is focused on a Web page, the present invention also relates to an entire Web site.

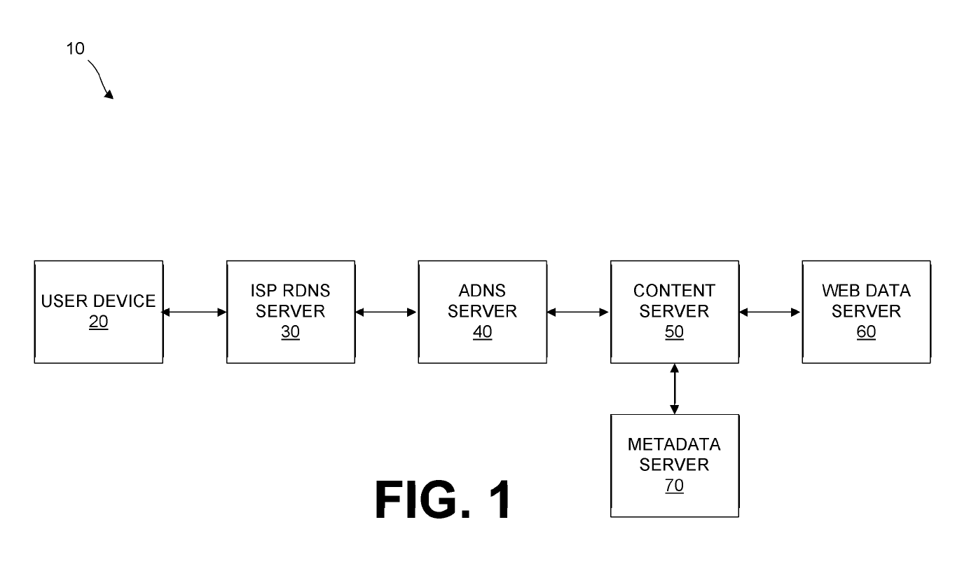

FIG. 1 is a schematic diagram illustrating a basic network 10 in which the present system and method is provided, in accordance with a first exemplary embodiment of the invention. It should be noted that the present invention may instead be provided in a different network. As a result, the basic network of FIG. 1 is not intended to limit the type of network in which the present system and method may be provided.

As is shown by FIG. 1, the network 10 contains a user device 20. It should be noted that the user device 20 could be one of many different devices such as, but not limited to, a desktop computer, a laptop, or a mobile phone. Specifically, the user device 20 is a device from which a user, or an individual, can make a request for access to a Web site via entry of a Web extension, such as www.domain.com. As a result, the user device contains an Internet/Web browser or other software application capable of allowing the user to view content stored at a remote location. In accordance with the present system and method, the content stored at a remote location is a Web site.

The user device 20 is connected via the Internet to an Internet service provider (ISP) recursive domain name system (RDNS) server 30. The ISP RDNS server 30 is responsible to the user for providing Internet access and provides translation of a received domain name into an Internet protocol (IP) address. The user may either select his/her ISP beforehand or have the ISP automatically assigned. The ISP provides the connection between the user device 20 and an ISP RDNS server 30. Of course, the user device 20 may also be capable of providing the translation of received domain names into an IP address. In such an embodiment, there would not be a need for an ISP RDNS server.

The ISP RDNS server 30 is connected, via the Internet, to one or more authoritative DNS (ADNS) server 40. It should be noted that the number of ADNS servers may be more than what is illustrated by FIG. 1. The ADNS server 40 is connected, via the Internet, to one or more content server 50, also referred to as a point of presence (POP). One having ordinary skill in the art would appreciate that the network 10 may have more than one content server 50. As is known by those having ordinary skill in the art, a content server provides an interface point between locations within a network, where the locations store content that is gathered by the content server prior to forwarding the content to the user device 20. Each content server 50 is connected, via the Internet, to one or more Web data server 60. The Web data server 60 contains content that is being sought by the user, specifically, the Web page or Web site.

The content server 50 is also connected to a Metadata server 100, thereby allowing the content server 50 to gather Metadata elements from the Metadata server 100, as is explained in detail herein. The Metadata server 100 has Metadata elements stored therein (i.e., Metatags) that may be used to populate a Web page.

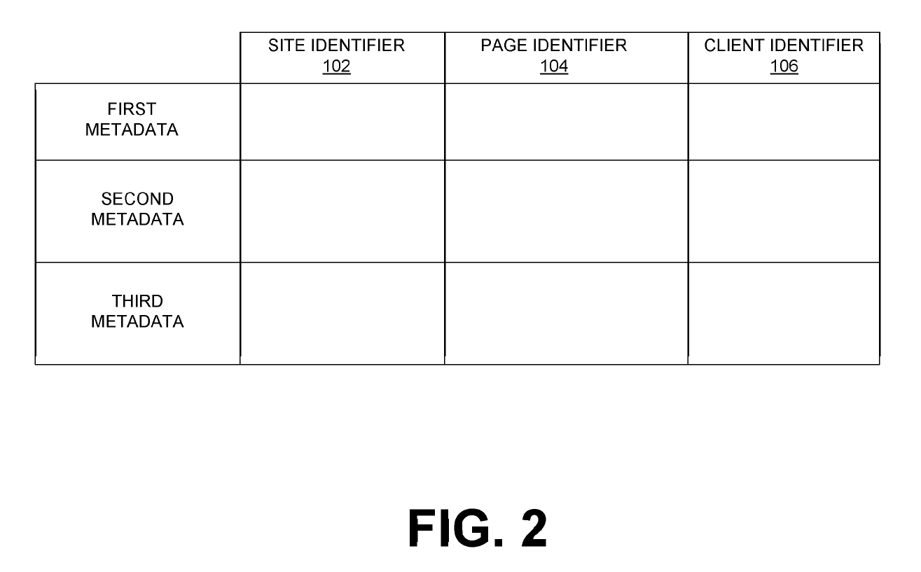

FIG. 2 is a schematic diagram further illustrating the Meta data server 100 storage structure. As shown by FIG. 2, Metadata elements, such as Meta tags, are stored with identifiers that allow the content server 50 to populate a Web page retrieved from the Web data server 60 with Metadata elements called by a calling function stored within the Web page. As previously mentioned, the calling function may be a script or code. Specifically, the calling function is incorporated as part of the code of the Web page, which is stored on the Web data server 60. As is described in further detail herein, when a Web page having a calling function therein is pulled by the content server 50, prior to the Web page being transmitted to the user device 20, code of the Web page is executed, including the incorporated calling function. The calling function, when executed, causes the content server 50 to call for Metadata elements from the Metadata server 100. The Metadata elements may be called by use of the identifiers mentioned above.

By having the Metadata elements stored at a location that is not controlled by the user of the user device 20, Metadata elements may be edited, deleted, and controlled by a party that is responsible for updating and maintenance of the Metadata elements. In addition, since the Metadata elements are populated into an associated Web page prior to the transmission of the Web page to the user device 20, one having ordinary skill in the art will appreciate that search engines that index Web pages and Web sites view the Metadata elements when indexing the completed Web pages and Web sites. As a result, a maintainer of the Metadata server 100 controls the search engine indexing of Web pages and Web sites having Metadata stored within the Metadata server 100.

It should be noted, that in accordance with an alternative embodiment of the invention, content stored within the Web data server 60 and the Metadata elements stored within the Metadata server 100 may be stored within the same server or storage device. In addition, the content from the Web data server 60 and/or the Metadata elements from the Metadata server 100 may instead be stored within the content server 50. Further, the Metadata elements, Web pages, and/or Web sites may instead be stored in a storage device or separate storage devices, thereby not requiring additional servers.

Referring to FIG. 2, each Metadata element may have one or more identifier used to identify the Metadata element so as to allow for proper identification and extraction by the content server 50. The identifier, or identifiers, may be stored with the Metadata element or stored at a remote location, however, the identifier, or identifiers, are stored so as to have an association with the Metadata element, allowing for the Metadata element to be called by referring or citing to the identifier(s).

For exemplary purposes, three identifiers are associated with each Metadata element, however it should be noted that one or more identifier may be associated with each Metadata element. It should be noted that identifiers different from the identifiers illustrated by FIG. 2 may be used. As a result, the identifiers illustrated in FIG. 2 are not intended to provide a limitation to identifiers that may be provided in accordance with the present invention. Instead, any identifier that may be used to provide for proper selection of Metadata elements may be used.

Identifiers associated with each Metadata element, three of which are shown for exemplary purposes, include a site identifier 102, a page identifier 104, and a customer identifier 106. In accordance with the present exemplary embodiment of the invention, the site identifier 102 identifies a Web site for which the Metadata element is stored. The page identifier 104 identifies with which Web page a Metadata element is associated. In addition, the customer identifier 106 identifies whether a customer is active or not active. Within the present system and method, a customer is a party that owns or is associated with the Web site or Web page having Metadata elements stored separate from the source code of the Web site or Web page. In addition, an active customer is a customer for which the process of automatically providing Metadata elements on a Web page or Web site is provided. A customer may remain active by one of many different ways, such as, but not limited to, paying a monthly fee to a party that maintains the Metadata and access to the same.

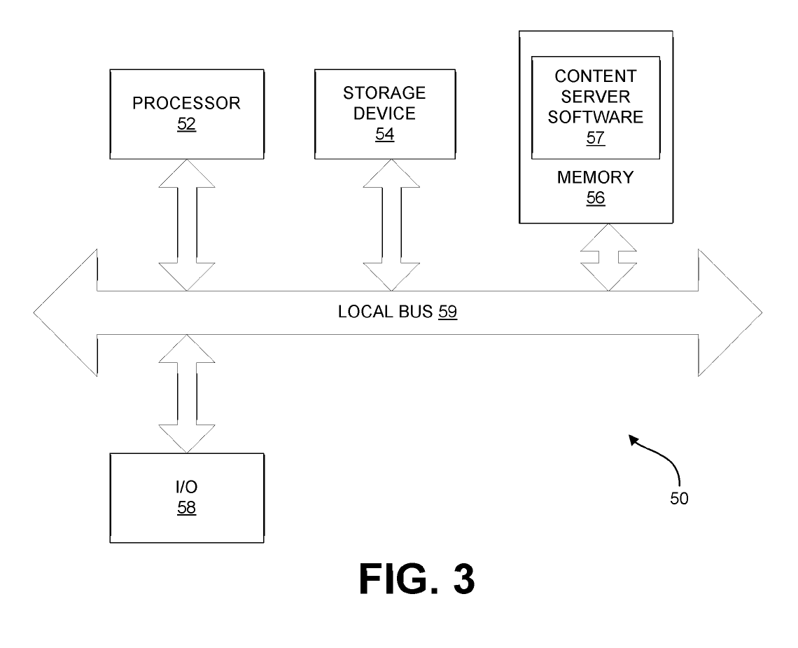

FIG. 3 is a block diagram further illustrating a typical content server 50. As is known by one having ordinary skill in the art, a typical content server 50 contains a processor 52, a storage device 54, a memory 56 having content server software 57 stored therein, input and output (I/O) devices 58 (or peripherals), and a local bus, or local interface 59 allowing for communication within the content server 50. The local interface 59 can be, for example but not limited to, one or more buses or other wired or wireless connections, as is known in the art. The local interface 59 may have additional elements, which are omitted for simplicity, such as controllers, buffers (caches), drivers, repeaters, and receivers, to enable communications. Further, the local interface 59 may include address, control, and/or data connections to enable appropriate communications among the aforementioned components.

The processor 52 is a hardware device for executing software, particularly that stored in the memory 56. The processor 52 can be any custom made or commercially available processor, a central processing unit (CPU), an auxiliary processor among several processors associated with the content server 50, a semiconductor based microprocessor (in the form of a microchip or chip set), a macroprocessor, or generally any device for executing software instructions.

The memory 56 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 56 may incorporate electronic, magnetic, optical, and/or other types of storage media. Note that the memory 56 can have a distributed architecture, where various components are situated remote from one another, but can be accessed by the processor 52.

The content server software 57 defines functionality performed by the content server 50, in accordance with the present invention. The software 57 in the memory 56 may include one or more separate programs, each of which contains an ordered listing of executable instructions for implementing logical functions of the content server 50, as described below. The memory 56 may contain an operating system (O/S) (not shown). The operating system essentially controls the execution of programs within the content server 50 and provides scheduling, input-output control, file and data management, memory management, and communication control and related services.

The I/O devices 58 may include input devices, for example but not limited to, a keyboard, mouse, scanner, microphone, etc. Furthermore, the I/O devices 58 may also include output devices, for example but not limited to, a printer, display, etc. Finally, the I/O devices 58 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the content server 50 is in operation, the processor 52 is configured to execute the content server software 57 stored within the memory 56, to communicate data to and from the memory 56, and to generally control operations of the content server 50 pursuant to the content server software 57. Such control operations include the retrieving of Web pages and Web sites, as well as retrieving Metadata elements, as instructed by the calling function stored on the Web page or Web site.

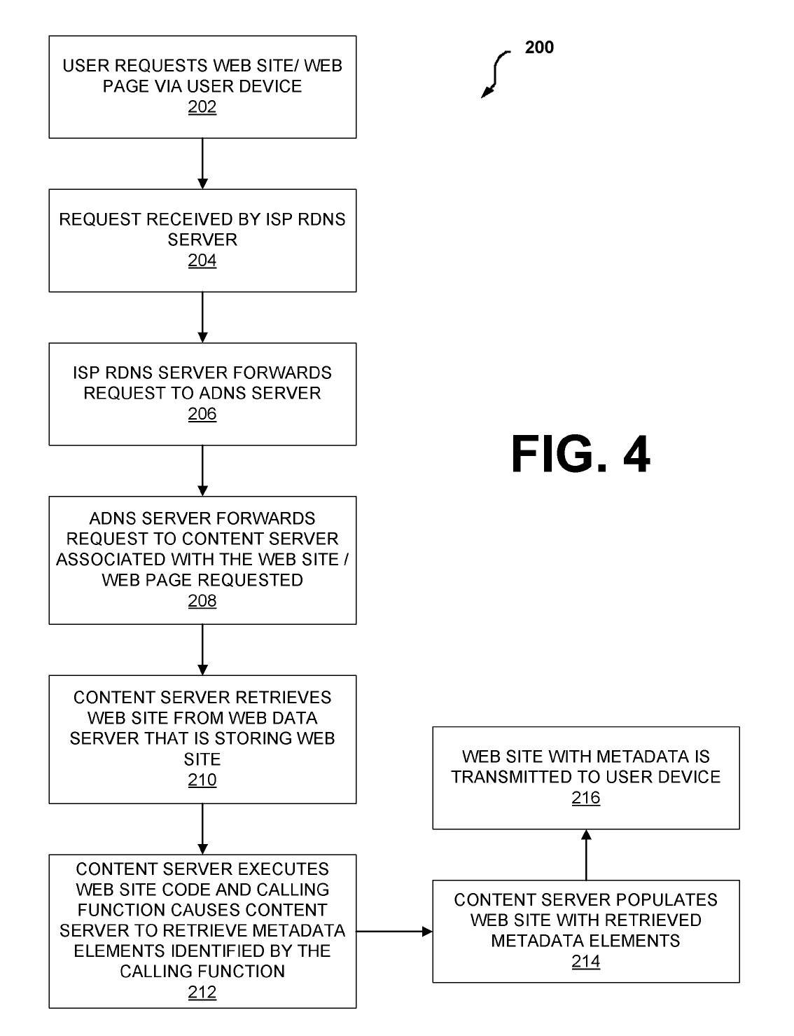

Having described the structure of the present system and method, the following provides a description of steps taken by the present system and method when a user of a client device 20 requests a Web site or Web page, where Metadata for the Web site or Web page is stored separate from the Web site or Web page. Specifically, FIG. 4 is a flow chart 200 illustrating the method used when a user of the client device 20 requests a Web site or Web page, where Metadata for the Web site or Web page is stored separate from the Web site or Web page, in accordance with a first exemplary embodiment of the invention. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 202, a user makes a request, via the user device 20, for a Web site or Web page, such as by using their Internet browser to search for a domain name in the format of www.domain.com. The request is received by the ISP RDNS server 30 (block 204). The ISP RDNS server 30 forwards the request to the ADNS server 40 (block 206).

After receipt of the user request from the ISP RDNS server 30, the ADNS server 40 forwards the user request to the content server 50 that is associated with the Web site requested by the user via the client device 20 (block 208). The content server 50 reviews the Web site request and retrieves the Web site from the Web data server 60 that is storing the Web site (block 210). As previously mentioned, the calling function that requests Metadata elements is stored within the code of the Web site. The calling function may be embodied as code, script, or any functionality that allows for retrieving of Metadata elements that are not previously stored within the code of the Web site.

When the content server 50 receives the code of the Web site, including the calling function, the content server 50 executes the code and the calling function causes the content server 50 to retrieve Metadata elements identified by the calling function (block 212). Specifically, the stored calling function of the Web site has identifiers stored therein, such as, for example, the site identifier 102, page identifier 104, and client identifier 106, so as to allow the content server 50 to identify the proper Metadata elements that are to populate the Web site. After the Metadata elements are retrieved by the content server 50, the content server populates the Web site with the retrieved Metadata elements (block 214).

While different methods may be used to populate the Web site with the Metadata elements, the following describes one example of a method that may be used. First, if Metadata elements are to be removed from the Web site prior to populating the Web site with new Metadata elements, a search is done for a Metadata header, such as, but not limited to, <title>, <meta name=description>, or <meta name=keywords>. The Metadata headers and associated content between the headers are then replaced with an empty string until all Metadata elements that are to be deleted are deleted.

The second step is to replace the empty strings with the new Metadata elements. Specifically, when a Web page is loading, a variable, referred to as $content for exemplary purposes, is filled with the HTML content information of the Web page. Another variable, referred to as $exactfactor_meta) is filled with the additional Metadata elements from the Metadata server 100.

For adding new Metadata elements from the Metadata server 100 to the Web page a search is performed in $content for a Metadata string and the string is replaced with Metadata elements from the Metadata server 100. As an example, there may be a search in $content for the string ‘<head>’ after which the string is replaced with ‘<head>’+$exactfactor_content’. Therefore, if $content=‘<HTML><head><title> title of a page </title></head><body></body></html>’, and $exactfactor_meta=‘<title> exactfactor </title>, the result will be ‘<HTML><head><title> exactfactor</title><title>newtitle</title></head><body></body></HTML>’

As shown by block 216, the Web site is transmitted back to the user device 20. Specifically, after populating the Web site with the retrieved Metadata elements, the content server 50 transmits the completed Web site to the ADNS server 40, for return to the ISP RDNS server 30, and finally, to the user device 20.

It should be noted that since the Metadata is populated at the “server side”, a search engine indexing a Web page or Web site is capable of viewing the Metadata so that the Web page or Web site is indexed according to the associated Metadata.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A system for automatically providing metadata elements on a Web page or Web site, comprising:
a user device having an application therein that allows the user to request access to a Web page or Web site;
a Web data server having at least one Web page and/or Web site stored therein;
a Metadata server having Metadata elements stored therein; and
a content server containing a memory and a processor, wherein the processor is configured by the memory to perform the steps of:
retrieving code of the requested Web page or Web site, wherein the code includes at least one calling function, wherein the calling function causes the content server to retrieve Metadata identified by the calling function, from the Metadata server;
reading the code of the requested Web page or Web site;
retrieving Metadata identified by the calling function, from the Metadata server; and
populating the Web page or Web site with the retrieved Metadata.

2. The system of claim 1, further comprising an Internet service provider recursive domain name system server capable of translating a domain name received from the user device and translating the domain name into an Internet protocol (IP) address.

3. The system of claim 1, wherein the Web data server and the Metadata server are the same server.

4. The system of claim 1, wherein the Metadata server stores said Metadata elements with at least one identifier capable of being used to identify Metadata elements for retrieval from the Metadata server.

5. The system of claim 1, wherein the calling function is Java script.

6. The system of claim 1, wherein Metadata elements are stored within the Metadata server with at least one identifier, wherein the at least one identifier is specified by the calling function to allow for retrieval of a specific Metadata element.

7. The system of claim 6, wherein the at least one identifier is selected from the group consisting of a site identifier, which identifies a Web site for which the Metadata element is stored, a page identifier, which identifies with which Web page a Metadata element is associated, and a client identifier which identifies whether a user is active or not active.

8. A content server; comprising:
a memory; and
a processor configured by the memory to perform the steps of:
retrieving code of a requested Web page or Web site, wherein the code includes at least one calling function, wherein the calling function causes the content server to retrieve Metadata identified by the calling function;
reading the code of the requested Web page or Web site;
retrieving Metadata elements identified by the calling function from a location remote from the content server; and
populating the Web page or Web site with the retrieved Metadata elements.

9. The content server of claim 8, wherein the calling function is Java script.

10. The content server of claim 8, wherein Metadata elements are stored with at least one identifier, wherein the at least one identifier is specified by the calling function to allow for retrieval of a specific Metadata element.

11. The content server of claim 10, wherein the at least one identifier is selected from the group consisting of a site identifier, which identifies a Web site for which the Metadata element is stored, a page identifier, which identifies with which Web page a Metadata element is associated, and a client identifier which identifies whether a user is active or not active.

12. A system for automatically providing metadata elements on a Web page or Web site, comprising:
a user device having an application therein that allows the user to request access to a Web page or Web site;
a content server containing a storage device having at least one Web page and/or Web site stored therein and Metadata elements stored therein, a memory and a processor, wherein the processor is configured by the memory to perform the steps of:
retrieving code of the requested Web page or Web site, wherein the code includes at least one calling function, wherein the calling function causes the content server to retrieve Metadata identified by the calling function;
reading the code of the requested Web page or Web site;
retrieving Metadata identified by the calling function; and
populating the Web page or Web site with the retrieved Metadata.

13. The system of claim 12, further comprising an Internet service provider recursive domain name system server capable of translating a domain name received from the user device and translating the domain name into an Internet protocol (IP) address.

14. The system of claim 12, wherein the storage device stores said Metadata elements with at least one identifier capable of being used to identify Metadata elements for retrieval.

15. The system of claim 12, wherein the calling function is Java script.

16. The system of claim 12, wherein Metadata elements are stored with at least one identifier, wherein the at least one identifier is specified by the calling function to allow for retrieval of a specific Metadata element.

17. The system of claim 16, wherein the at least one identifier is selected from the group consisting of a site identifier, which identifies a Web site for which the Metadata element is stored, a page identifier, which identifies with which Web page a Metadata element is associated, and a client identifier which identifies whether a user is active or not active.

18. A method for automatically providing Metadata elements in a Web page or Web site, comprising the steps of:
retrieving code of a requested Web page or Web site, wherein the code includes at least one calling function;
reading the code of the requested Web page or Web site;
retrieving Metadata elements identified by the calling function; and
populating the Web page or Web site with the retrieved Metadata elements.

19. The method of claim 18, further comprising the step of transmitting the populated Web page or Web site to a remote location.

20. The method of claim 18, wherein the Metadata elements are associated with at least one identifier, wherein the at least one identifier is specified by the calling function to allow for retrieval of a specific Metadata element.

21. The system of claim 20, wherein the at least one identifier is selected from the group consisting of a site identifier, which identifies a Web site for which the Metadata element is stored, a page identifier, which identifies with which Web page a Metadata element is associated, and a client identifier which identifies whether a user is active or not active.
